(19) United States
(12) Patent Application Publication
(10) Pub. No.: US 2005/0280606 A1
(43) Pub. Date: Dec. 22, 2005

(54) Method and apparatus of driving a plasma display panel

(76) Inventor: Joong Seo Park, Daegu (KR)

Correspondence Address: MCKENNA LONG & ALDRIDGE LLP, 1900 K STREET, NW, WASHINGTON, DC, 20006, US

(21) Appl. No.: 10/983,095

(22) Filed: Nov. 8, 2004

(30) Foreign Application Priority Data
Nov. 8, 2003 (KR) 10-2003-0078878

(51) Int. Cl. G09G 3/28

(52) U.S. Cl. 345/60

(57) ABSTRACT

The present invention relates to a plasma display panel, and more particularly, to a method and apparatus of driving a plasma display panel. According to an embodiment of the present invention, the method includes the steps of dividing a screen into two or more blocks, and performing an address in the first block of the blocks and then performing an address in the second block of the blocks, wherein a time interval between an address start of the first block and an address start of the second block ranges from 0 to 5 ms. Therefore, in the case where a screen is driven with it being divided into two or more blocks, a difference in brightness between the blocks can be minimized in such a way that an address start time point between the blocks is made different as much as a time interval which is set such that a difference in brightness between the blocks is not shown. Further, according to the present invention, flicker, etc., which is shown when two blocks are driven in the same manner without a time interval, can be prevented.

This Nonprovisional application claims priority under 35 U.S.C. § 119(a) on Patent Application No. 10-2003-0078878 filed in Korea on Nov. 8, 2003, the entire contents of which are hereby incorporated by reference.

### BACKGROUND OF THE INVENTION

1. Field of the Invention

The present invention relates to a plasma display panel, and more particularly, to a method and an apparatus of driving a plasma display panel.

2. Description of the Background Art

A plasma display panel (hereinafter, referred to as a ‘PDP’) is adapted to display an image by light-emitting phosphors with ultraviolet generated during the discharge of a gas such as He+Xe, Ne+Xe or He+Ne+Xe. This PDP can be easily made thin and large, and it can provide greatly increased image quality with the recent development of the relevant technology. Particularly, a three-electrode AC surface discharge type PDP has advantages of lower driving voltage and longer product lifespan as a wall charge is accumulated on a surface in discharging and electrodes are protected from sputtering caused by discharging.

Referring to FIG. 1, in the conventional three-electrode AC surface discharge type PDP, a n number of scan electrodes Y1 to Yn and a n number of common sustain electrodes Z intersect a m number of data electrodes X1 to Xm with discharge spaces intervened therebetween. A m x n number of cells are formed at the intersections. Barrier ribs 2 for preventing electrical and optical interference among the cells that are neighboring each other horizontally are formed between the neighboring data electrodes X1 to Xm.

The scan electrodes Y1 to Yn generate a sustain discharge in cells which are selected in such a manner that a scan signal is sequentially applied to the scan electrodes to select a scan line, and a sustain pulse is then commonly applied to the scan electrodes. The common sustain electrodes Z generate a sustain discharge in cells which are selected in such a way that a sustain pulse that is applied alternately with the sustain pulse applied to the scan electrodes Y1 to Yn is applied to the sustain electrodes Z. The data electrodes X1 to Xm select the cells 1 as a data pulse synchronized with the scan signal is applied.

The PDP is time-driven with a frame period (NTSC mode: 16.67 ms) constituting one screen being divided into several sub-fields having a different number of emission in order to implement the gray scale of an image. Each of the sub-fields is divided into a reset period for initializing the entire screen, an address period for selecting a scan line and selecting a cell from the selected scan line, and a sustain period (or a display period) for implementing the gray scale depending on the number of a discharge. For example, if it is desired to display an image with 256 gray scale, the frame period (16.67 ms) corresponding to 1/60 seconds is divided into eight sub-fields SF1 to SF8, as shown in FIG. 2. Furthermore, each of the eight sub-fields SF1 to SF8 is subdivided into the reset period, the address period and the sustain period, as described above. In this time, the reset period and the address period of each of the sub-fields are the same every sub-field, whereas the display period increases in the ratio of 2ⁿ(n=0,1,2,3,4,5,6,7) in each sub-field.

However, if the whole scan lines SC1 to SCn of the PDP are driven in a so-called ‘ADS (Address & Display Separated)’ mode in which an address period and a sustain period are separated from each other as shown in FIG. 2, there is a problem in that an image cannot be displayed with high brightness and high picture quality since the sustain period is reduced due to an increased address period. In this time, one scan line includes one row of cells to which data is supplied in response to the same scan signal. For example, if sub-fields are added in order to increase resolution or to reduce pseudo contour noise in a motion picture, which is accompanied by an increased number of the scan lines SC1 to SCn and an increased number of the cells 1, a non-display period, particularly, the address period becomes long within a limited time. Accordingly, the sustain period being a display period is relatively reduced.

In order to solve the shortage of this driving time, the applicant of the present invention proposed a method and apparatus for reducing the address period in which the sustain electrodes are replaced with scan electrodes that can be scanned in FIG. 1, and the screen is divided into a plurality of blocks so that scanning is possible in each of the blocks. (see U.S. Pat. No. 6,288,693). According to this conventional method and apparatus, any one of the plurality of the blocks operates as the address period so that scanning is performed, and at least one of the plurality of the blocks except for the aforementioned block operates as the sustain period so that a sustain discharge is performed. For example, in the case where a PDP is driven with it being divided into two blocks as shown in FIG. 3, when the upper half block operates as the address period, the lower half block operates as the sustain period. If one of the blocks operates as the sustain period within the same screen during a predetermined period while the other of the blocks operates as the address period, there is a problem in that brightness within the same one screen is different.

Further, as another separation driving method, there may be a method in which different blocks operate as the address period or the sustain period at the same time, as shown in FIG. 4. In this method, however, there is a problem in that flicker is generated since the emission center point is located at the same time point every frame.

### SUMMARY OF THE INVENTION

Accordingly, an object of the present invention is to solve at least the problems and disadvantages of the background art.

An object of the present invention is to provide a method and apparatus for driving a PDP, in which a difference in brightness between blocks is minimized when a screen is driven with it being divided into two or more blocks.

To achieve the above object, according to an embodiment of the present invention, there is provided a method of driving a PDP, including the steps of dividing a screen into two or more blocks, and performing an address in the first block of the blocks and then performing an address in the second block of the blocks. A time interval between an address start of the first block and an address start of the second block is set to be within a range between 0 and 5 ms.

According to an embodiment of the present invention, there is provided an apparatus for driving a plasma display panel, including the plasma display panel divided into two or more blocks, and a driving unit that performs an address in the first block of the blocks and then performs an address in the second block of the blocks. The driving unit controls a time interval between an address start of the first block and an address start of the second block to be within a range between 0 and 5 ms.

According to the present invention, in the case where a screen is driven with it being divided into two or more blocks, a difference in brightness between the blocks can be minimized in such a way that an address start time point between the blocks is made different as much as a time interval which is set so that a difference in brightness between the blocks is not shown. Further, according to the present invention, flicker, etc., which is shown when two blocks are driven in the same manner without a time interval, can be prevented.

### BRIEF DESCRIPTION OF THE DRAWINGS

The invention will be described in detail with reference to the following drawings in which like numerals refer to like elements.

FIG. 1 is a plan view showing arrangement of electrodes of a three-electrode AC surface discharge type PDP in the prior art.

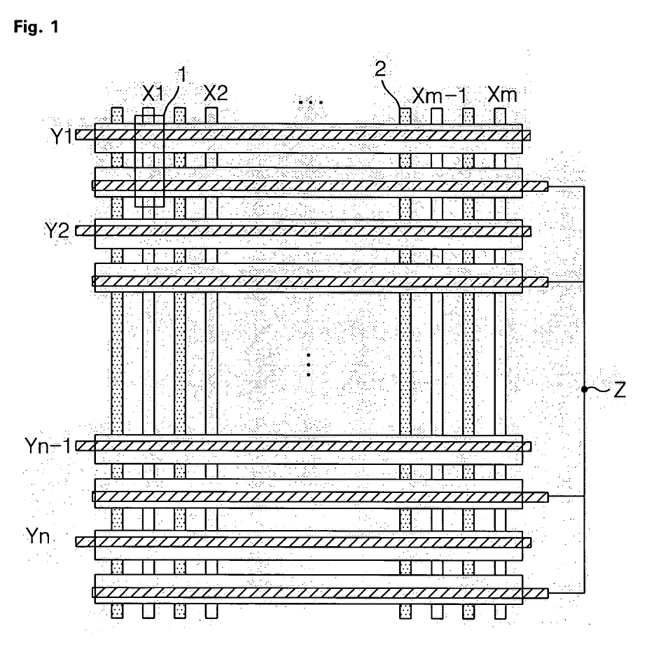

FIG. 2 shows the configuration of one frame of the conventional PDP.

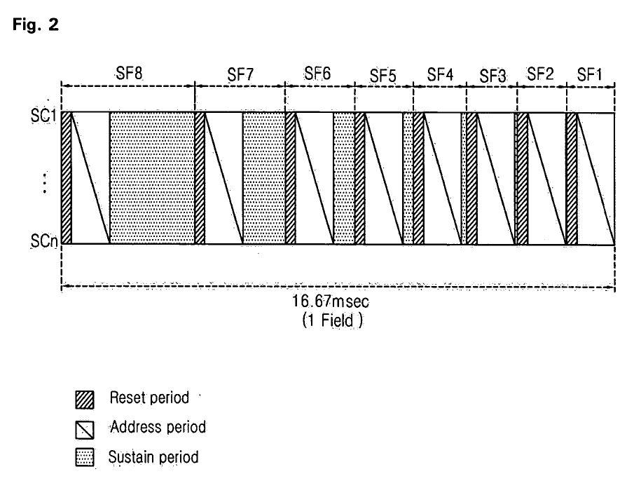

FIG. 3 shows an example of separated driving.

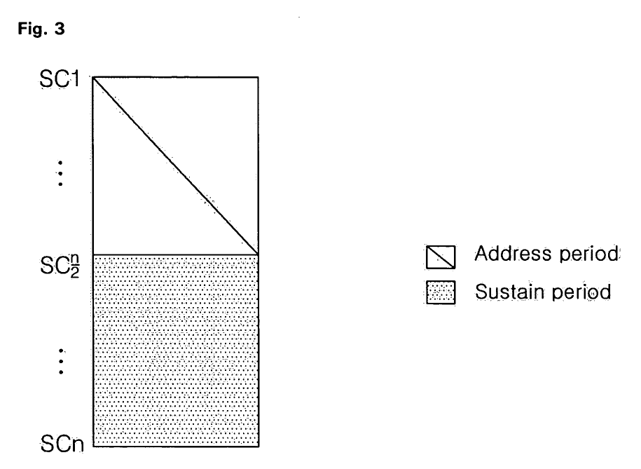

FIG. 4 shows another example of separated driving.

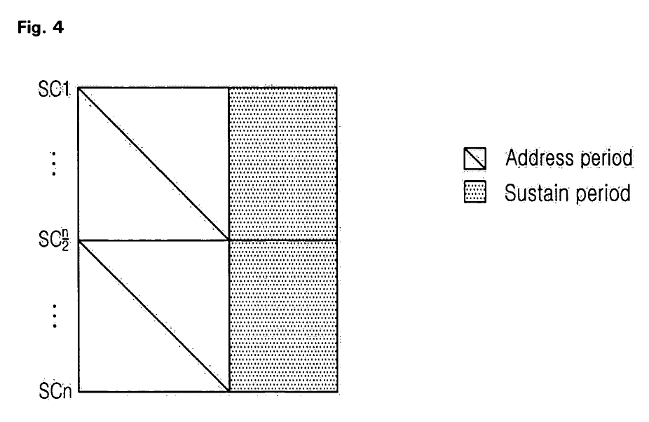

FIG. 5 shows the configuration of one frame of a upper half block and a lower half block in the method of driving the PDP according to an embodiment of the present invention.

FIG. 6 is a block diagram illustrating the construction of an apparatus for driving a PDP according to an embodiment of the present invention.

FIG. 7 shows a waveform for explaining a driving signal generated by the driving unit shown in FIG. 6.

### DETAILED DESCRIPTION OF PREFERRED EMBODIMENTS

Preferred embodiments of the present invention will be described in a more detailed manner with reference to the drawings.

According to an embodiment of the present invention, there is provided a method of driving a PDP, including the steps of dividing a screen into two or more blocks, and performing an address in the first block of the blocks and then performing an address in the second block of the blocks.

A time interval between an address start of the first block and an address start of the second block is set to be within a range between 0 and 5 ms.

The step of performing the address further includes the steps of supplying data to data electrodes of the first block and simultaneously supplying a scan pulse to scan electrodes of the first block, and supplying data to the data electrodes of the second block which are separated from the data electrodes of the first block and simultaneously supplying the scan pulse to the scan electrodes of the second block.

The method of driving the PDP according to an embodiment of the present invention further includes the step of generating a sustain discharge in each of the blocks after the address has been performed.

The data is either a write data for selecting on-cells to be turned on, or an erase data for selecting off-cells to be turned off.

The step of performing the address further includes the steps of supplying the write data to the data electrodes in a selective writing sub-field, and supplying the erase data to the data electrodes in a selective erasing sub-field.

The time interval between the address start of the first block and the address start of the second block is smaller than a sub-field period of a maximum brightness weight.

According to an embodiment of the present invention, there is provided an apparatus for driving a plasma display panel, including the plasma display panel divided into two or more blocks, and a driving unit that performs an address in the first block of the blocks and then performs an address in the second block of the blocks.

The driving unit controls a time interval between an address start of the first block and an address start of the second block to be within a range between 0 and 5 ms.

The driving unit includes a first driving unit that supplies data to data electrodes of the first block and simultaneously supplies a scan pulse to scan electrodes of the first block, and a second driving unit that supplies data to the data electrodes of the second block which are separated from the data electrodes of the first block and simultaneously supplies the scan pulse to the scan electrodes of the second block.

The apparatus for driving the PDP according to an embodiment of the present invention further includes a sustain driving unit that generates a sustain discharge in each of the blocks after the address has been performed.

The data is either a write data for selecting on-cells to be turned on, or an erase data for selecting off-cells to be turned off.

The driving units supply the write data to the data electrodes in a selective writing sub-field and supply the erase data to the data electrodes in a selective erasing sub-field.

The time interval between the address start of the first block and the address start of the second block is smaller than a sub-field period of a maximum brightness weight.

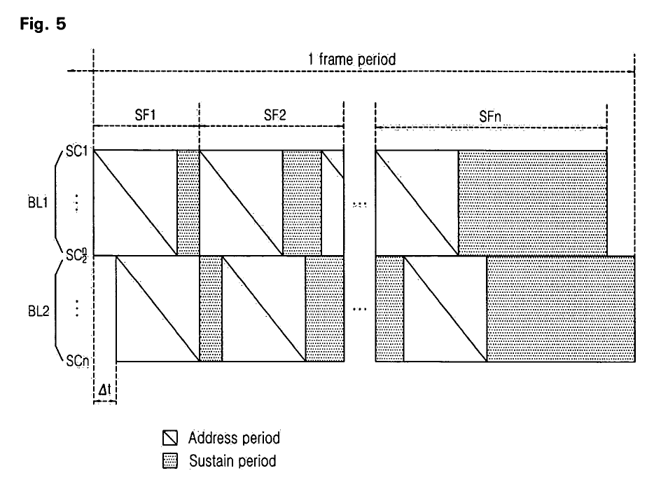

FIG. 5 shows the configuration of one frame of an upper half block and a lower half block in a method of driving a PDP according to an embodiment of the present invention.

Referring to FIG. 5, in the method of driving the PDP according to the first embodiment of the present invention, the PDP is driven with it being divided into an upper half block BL1 and a lower half block BL2. Address and scanning of the upper half block BL1 and the lower half block BL2 are initiated at a given time interval (Δt).

Each of the upper half block BL1 and the lower half block BL2 is time-driven as a N number of sub-fields during 1 frame period. In this time, the sub-fields in each of the blocks BL1, BL2 are arranged in order from a sub-field whose brightness weight is low to a sub-field whose brightness weight is high and vice versa, as shown in FIG. 5. Further, the sub-fields in each of the blocks BL1, BL2 can be arranged in such a way that brightness weight of the sub-fields become discontinuous or random in order to reduce factors that reduce the picture quality such as motion picture pseudo contour noise. Moreover, the sub-fields in each of the blocks BL1, BL2 can be arranged in such a manner that the address periods of the sub-fields are concentrated and the address centralization periods are not overlapped between the blocks BL1, BL2 during a short time, as disclosed in U.S. Pat. No. 6,288,693.

In the driving method of the PDP according to the present invention, it is required that even if the sub-fields are arranged in any mode, the address period and the sustain period of the upper half block BL1 and the lower half block BL2 be overlapped and an address start time point or a scanning start time point of the two blocks BL1, BL1 be separated at a given time interval (Δt) during at least some period of one frame period. The address time interval (Δt) is set to a time interval where a difference in brightness between the two blocks BL1, BL2 is rarely shown when the two blocks BL1, BL2 are seen with the naked eye at the same time. In the concrete, the address time interval (Δt) is set to a time ranging from 0 ms to 5 ms, preferably 0 ms to 2 ms. Further, the address time interval (Δt) must be set within the period of a sub-field having the highest brightness weight, e.g., a N^{th} sub-field SFN in FIG. 5 so that a difference in brightness is not shown between the two blocks BL1, BL2.

Korean Patent Application Nos. 10-2000-0012669, 10-2000-0053214, 10-2001-0003003, 10-2001-0006492, 10-2002-0082512, 10-2002-0082513, 10-2002-0082576 and the like, all of which were filed by the applicant of the present invention, disclose a so-called ‘SWSE (Selective Writing and Selective Erasure) mode’ in which on-cells are selected by a write discharge during an address period in some of sub-fields existing within one frame period and off-cells are selected by an erase discharge during an address period in other sub-fields.

In the driving method of the PDP according to the present invention, the sub-fields arranged within one frame period can include sub-fields of the aforementioned SWSE mode. In this case, as the address period can be reduced further, it is advantageous in high-speed driving. Moreover, in the driving method of the PDP according to the present invention, the sub-fields can be arranged in a selective writing mode in which only a plurality of sub-fields that select on-cells during the address period are included, or a selective erasing mode in which only a plurality of sub-fields that select off-cells during the address period are included.

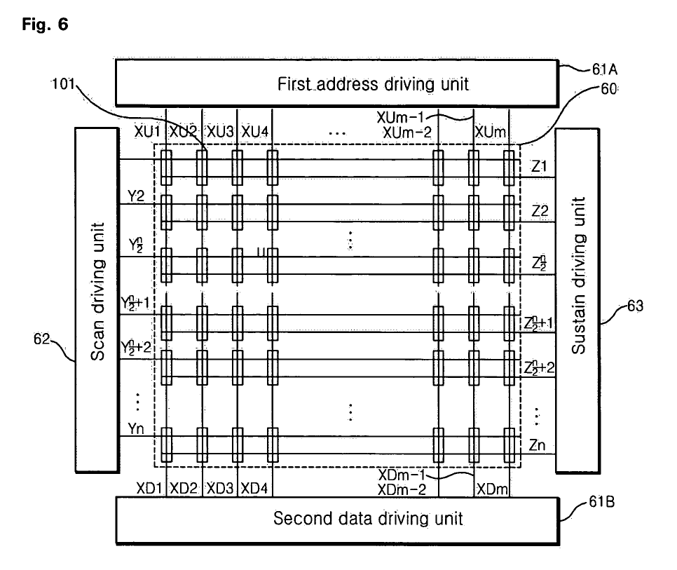

FIG. 6 is a block diagram illustrating the construction of an apparatus for driving a PDP according to an embodiment of the present invention.

Referring to FIG. 6, the apparatus for driving the PDP according to an embodiment of the present invention includes a PDP 60 in which data electrodes XU1 to XUm, XD1 to XDm are divided between an upper half section and a lower half section, a first data driving unit 61A for supplying data to the data electrodes XU1 to Xum of an upper half block BL1, a second data driving unit 61B for supplying data to the data electrodes XD1 to XDm of a lower half block BL2, a scan driving unit 62 for driving scan electrodes Y1 to Yn, and a sustain driving unit 63 for driving sustain electrodes Z1 to Zn.

In the DDP 60, the divided data electrodes XU1 to XUn, XD1 to XDn intersect the scan electrodes Y1 to Yn and the sustain electrodes Z1 to Zn. Cells 101 are formed at those intersections.

The first data driving unit 61A supplies a write data or an erase data to the data electrodes XU1 to Xum of the upper half block BL1 during an address period of the upper half block BL1 under the control of timing control means (not shown).

The second data driving unit 61B supplies the write data or the erase data to the data electrodes XD1 to XDm of the lower half block BL1 during the address period of the lower half block BL2 under the control of the timing control means. The second data driving unit 60B generates a second data after a predetermined time interval (Δt) from a time where the first data is generated by the first data driving unit 60A. The write data is data for selecting on-cells to be turned on by a write discharge in the sub-fields of the aforementioned selective writing mode. On the contrary, the erase data is data for selecting off-cells to be turned off by an erase discharge in the sub-fields of the aforementioned selective erasing mode.

The scan driving unit 62 sequentially applies a scan pulse to the scan electrodes Y1 to Yn/2 during the address period of the upper half block BL1, and at the same time, sequentially applies the scan pulse to the scan electrodes Yn/2+1 to Yn during the address period of the lower half block BL2, which begins after the predetermined time interval (Δt) from the first scan pulse that is generated for the first time in the upper half block BL1, under the control of the timing control means. Further, the scan driving unit 62 applies a sustain pulse to the scan electrodes Y1 to Yn during a sustain period of the upper half block BL1 and the lower half block BL2.

The sustain driving unit 63 serves to apply a DC bias voltage of the positive polarity to the sustain electrodes Z1 to Zn during the address periods of the upper half block BL1 and the lower half block BL2, and also apply the sustain pulse to the sustain electrodes Z1 to Zn during the sustain period while alternately operating with the scan driving unit 63, under the control of the timing control means.

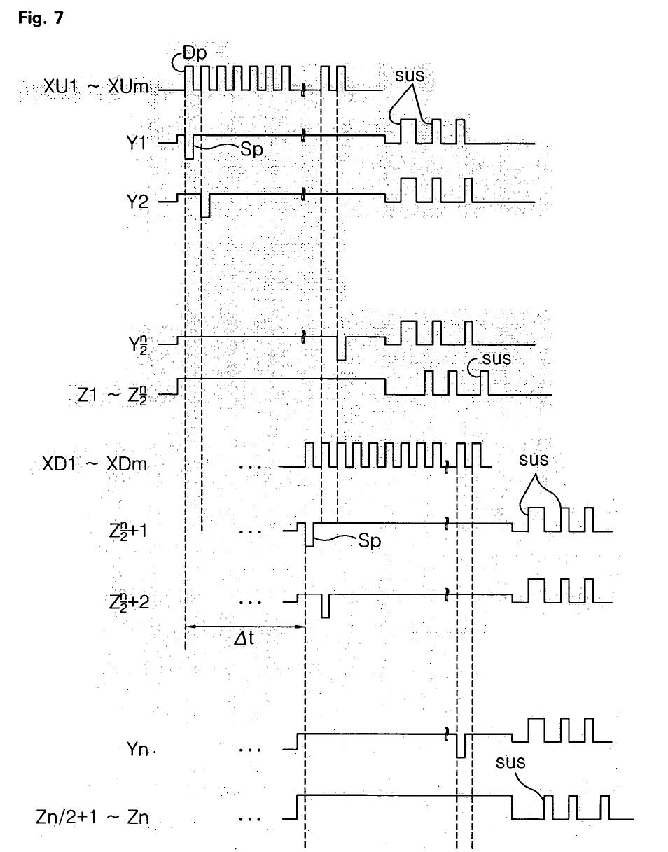

FIG. 7 shows driving waveforms generated by the driving units 61A, 61B, 62 and 63 shown in FIG. 6.

In FIG. 7, an initialization waveform generated in a reset period is omitted.

Referring to FIG. 7, during the address period of the upper half block BL1, the first data driving unit 61A supplies write or erase data Dp to the address electrodes XU1 to Xun of the upper half block BL1, and the scan driving unit 62 sequentially applies a scan pulse Sp that is synchronized with data of the upper half block BL1 to the first to (n/2)^{th} scan electrodes Y1 to Yn/2.

In the upper half block BL1, after a predetermined time interval (Δt) since the first data pulse Dp and the scan pulse Sp are generated, the address period of the lower half block BL2 begins. During the address period of the lower half block BL2, the second data driving unit 62A supplies the write or erase data Dp to the address electrodes XD1 to XDn of the lower half block BL2, and the scan driving unit 62 sequentially applies the scan pulse Sp that is synchronized with data of the lower half block BL2 to the (n/2+1)^{th} to n^{th} scan electrodes Yn/2+1 to Yn.

As such, in the upper half block BL1 and the lower half block BL2, the address periods are overlapped and two or more lines are scanned at the same time within their overlapping period. Therefore, the address period is reduced.

As such, as the address discharge is generated in each of the upper half block BL1 and the lower half block BL2, the sustain pulse Sus is applied to the scan electrodes Y1 to Yn and the sustain electrodes Z1 to Zn in each of the upper half block BL1 and the lower half block BL2 after on-cells or off-cells are selected. Accordingly, the sustain discharge is generated within the on-cells.

Meanwhile, unlike the description made with reference to FIGS. 5 and 7, the lower half block BL2 can be scanned first and the upper half block BL1 can be scanned after a predetermined time interval.

It has been described in the embodiment of the present invention that the PDP is driven with it being divided into two blocks; the upper and lower half sections. It is, however, to be noted that the method and apparatus of driving the PDP according to the present invention are not limited to the above embodiment, but the PDP can be driven with it being divided into a k number of blocks in which an address electrodes is divided into a k number.

As described above, according to the present invention, in the case where a screen is driven with it being divided into two or more blocks, a difference in brightness between the blocks can be minimized in such a way that an address start time point between the blocks is made different as much as a time interval which is set so that a difference in brightness between the blocks is not shown. Further, according to the present invention, flicker, etc., which is shown when two blocks are driven in the same manner without a time interval, can be prevented.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of driving a plasma display panel, comprising the steps of:
dividing a screen into two or more blocks; and
performing an address in the first block of the blocks and then performing an address in the second block of the blocks,
wherein a time interval between an address start of the first block and an address start of the second block ranges from 0 to 5 ms.

2. The method as claimed in claim 1, wherein the step of performing the address further comprises the steps of: supplying data to data electrodes of the first block and simultaneously supplying a scan pulse to scan electrodes of the first block; and supplying data to the data electrodes of the second block which are separated from the data electrodes of the first block and simultaneously supplying the scan pulse to the scan electrodes of the second block.

3. The method as claimed in claim 1, further comprising the step of generating a sustain discharge in each of the blocks after the address has been performed.

4. The method as claimed in claim 2, wherein the data is either a write data for selecting on-cells to be turned on, or an erase data for selecting off-cells to be turned off.

5. The method as claimed in claim 4, wherein the step of performing the address further comprises the steps of: supplying the write data to the data electrodes in a selective writing sub-field; and supplying the erase data to the data electrodes in a selective erasing sub-field.

6. The method as claimed in claim 1, wherein the time interval between the address start of the first block and the address start of the second block is smaller than a sub-field period of a maximum brightness weight.

7. An apparatus for driving a plasma display panel, comprising:
the plasma display panel divided into two or more blocks; and
a driving unit that performs an address in the first block of the blocks and then performs an address in the second block of the blocks,
wherein the driving unit controls a time interval between an address start of the first block and an address start of the second block to be within a range between 0 and 5 ms.

8. The apparatus as claimed in claim 7, wherein the driving unit comprises:
a first driving unit that supplies data to data electrodes of the first block and simultaneously supplies a scan pulse to scan electrodes of the first block; and
a second driving unit that supplies data to the data electrodes of the second block which are separated from the data electrodes of the first block and simultaneously supplies the scan pulse to the scan electrodes of the second block.

9. The apparatus as claimed in claim 7, further comprising a sustain driving unit that generates a sustain discharge in each of the blocks after the address has been performed.

10. The apparatus as claimed in claim 8, wherein the data is either a write data for selecting on-cells to be turned on, or an erase data for selecting off-cells to be turned off.

11. The apparatus as claimed in claim 10, wherein the driving units supply the write data to the data electrodes in a selective writing sub-field and supply the erase data to the data electrodes in a selective erasing sub-field.

12. The apparatus as claimed in claim 7, wherein the time interval between the address start of the first block and the address start of the second block is smaller than a sub-field period of a maximum brightness weight.
